(19) United States
(12) Patent Application Publication
(10) Pub. No.: US 2010/0074284 A1
(43) Pub. Date: Mar. 25, 2010

(54) LIGHT SOURCE UNIT AND IMAGE DISPLAYING APPARATUS USING THE SAME

(75) Inventors: Jyunichi AIZAWA, Tokyo (JP); Yukio Sato, Tokyo (JP); Mitoru Yabe, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 12/564,346

(22) Filed: Sep. 22, 2009

(30) Foreign Application Priority Data
Sep. 22, 2008 (JP) 2008-242342

(51) Int. Cl. H01S 3/13; H04N 9/31

(52) U.S. Cl. 372/29.02; 348/744

(57) ABSTRACT

An object is to provide a light source unit that focuses a laser beam having different divergence angles in longitudinal direction and lateral direction, without deviating longitudinally and laterally from an incident end-face of an optical fiber, and also that simplifies assembling lenses into a lens barrel. The light source unit herein provided includes a first lens barrel 1 that holds cylindrical lenses 10 and 11, and 12 for forming a parallel-ray laser beam by refracting the laser beam 9 having different divergence angles in longitudinal direction and lateral direction emitted from a laser element 7, a second lens barrel 2 that holds circular lenses 13 and 14 for focusing the parallel-ray laser beam onto the entrance of the optical fiber 3, and a lens holder 15 that holds at least one of the cylindrical lenses and is inserted into the first lens barrel 1 and fixed therein.

### TECHNICAL FIELD

The present invention relates to light source units for use in a laser device requiring a laser beam transferred through an optical fiber, for example, a projector or a rear projection television in which images are projected onto a screen using the laser beam as a light source, or in a liquid-crystal television using it as a backlight.

### BACKGROUND ART

In a conventional light source unit, a collimation lens is used for forming a laser beam emitted from a semiconductor laser into a parallel-ray light beam, which is afterward focused by a plano-convex lens to obtain a light beam having a band-like cross-section. And then, the collimation lens and the piano-convex lens are held by separate lens barrels, and the two lens barrels are further held by their outer supporting part (for example, refer to Japanese Patent Application Publication No. H05-93881, Paragraphs 0024, 0032, FIG. 2). In addition, in another example, divergent light emitted from a laser diode (LD) having an elliptical cross-section is transformed into collimated light by an LD collimation lens (convex lens), and is focused by a fiber collimation lens (convex lens) so as to be incident to an optical fiber. Both the LD collimation lens and the fiber collimation lens are held and fixed in a lens holder, and further the lens holder is inserted into a lens sleeve and held thereby. (For example, refer to Japanese Patent Application Publication No. 2003-329893, Paragraphs 0015, 0032, FIG. 1). Moreover, in another example, after having collimated emission light from laser elements by collimation lenses each into a parallel-ray laser beam, focusing onto the front end of an optical fiber is performed using two pieces of light-focusing or condenser lenses (a cylindrical lens and an anamorphic lens). Note that, the two condenser lenses are together held in a condenser lens holder (for example, refer to Japanese Patent Application Publication No. 2007-67271, Paragraphs 0023, 0024, 0038, FIG. 2).

### Problems to be Solved by the Invention

In such light source units disclosed in Japanese Patent Application Publication No. H05-93881 and in Japanese Patent Application Publication No. 2000-121888, a cylindrical lens is not used, so that it is difficult to form a laser beam whose longitudinal and lateral divergence angles are different with each other, into a parallel-ray laser beam, and even when a laser beam is focused by using a light-focusing or condenser lens, after it has passed through a collimation lens, focusing onto an incident end-face of an optical fiber cannot be achieved. In a light source unit in Japanese Patent Application Publication No. 2007-67271, a cylindrical lens is used; however the two condenser lenses are held by means of one lens barrel, so that it is difficult to assemble one of the condenser lenses to be held at a position set far back in the lens barrel.

Moreover, in the light source unit in Japanese Patent Application Publication No. H05-93881, a lens barrel that holds the collimation lens and a lens barrel that holds the plano-convex lens are held by their outer supporting part; however, the lens barrels are only placed on the supporting part, so that it is difficult to accurately make the optical axes of these two pieces of lenses coincide with each other. In addition, in the light source unit in Japanese Patent Application Publication No. 2003-329893, a lens holder that holds an LD collimation lens and a fiber collimation lens is inserted into a lens sleeve and held thereby; however, the lens holder (lens barrel) is a single piece member, causing such a problem that particularly assembling the lenses into the lens holder cannot be completed simply.

The present invention has been directed at solving those problems described above, and an object of the invention is to longitudinally and laterally focus a laser beam emitted from a laser element having different divergence angles in longitudinal direction and lateral direction, and at the same time, to simplify assembling those lenses into a lens barrel.

### SUMMARY OF THE INVENTION

### Means for Solving the Problems

A light source unit according to the present invention comprises at least one cylindrical lens placed with its generatrix perpendicular to an optical axis of laser beam for forming a parallel-ray laser beam by refracting the laser beam having different divergence angles in longitudinal direction and lateral direction emitted from a laser element; a condenser lens placed downstream of the at least one cylindrical lens for focusing the parallel-ray laser beam; a lens holder for holding the at least one cylindrical lens; a first lens barrel into which the lens holder is inserted; and a second lens barrel mounted on the first lens barrel for holding the condenser lens so that an optical axis thereof coincides with an optical axis of the at least one cylindrical lens.

### Effects of the Invention

According to the present invention, a laser beam emitted from a laser element having different divergence angles in longitudinal direction and lateral direction is refracted by at least one cylindrical lens so as to form the beam into a longitudinally and laterally parallel-ray laser beam, and therefore, the laser beam can be easily focused using a condenser lens after having the beam passed through the cylindrical lens. In addition, the at least one cylindrical lens is held by means of a lens holder forming a sub-assembly that is inserted into the first lens barrel so as to be fixed, so that assembling the cylindrical lens can be easily and accurately performed.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a perspective diagram illustrating a light source unit in Embodiment 1 of the present invention;

FIG. 2 is a lateral section diagram illustrating the light source unit in Embodiment 1 of the present invention;

FIG. 3 is a longitudinal section diagram illustrating the light source unit in Embodiment 1 of the present invention;

FIG. 4 is a perspective diagram illustrating a lens unit that holds cylindrical lenses of the light source unit in Embodiment 1 of the present invention, where part of the unit is taken to show the cross section;

FIG. 5 is a perspective view showing the lens unit that holds the cylindrical lenses of the light source unit in Embodiment 1 of the present invention;

FIG. 6 is a perspective view showing a sub-assembly unit that holds a cylindrical lens of the light source unit in Embodiment 1 of the present invention;

FIG. 7 is a perspective view showing the sub-assembly unit that holds the cylindrical lens of the light source unit in Embodiment 1 of the present invention;

FIG. 8 is a cross-sectional diagram showing the sub-assembly unit that holds the cylindrical lens of the light source unit in Embodiment 1 of the present invention;

FIG. 9 is a perspective view showing a lens holder of the light source unit in Embodiment 1 of the present invention;

FIG. 10 is a perspective diagram illustrating a state in which the cylindrical lens is placed in the lens holder of the light source unit in Embodiment 1 of the present invention;

FIG. 11 is a perspective diagram illustrating a state in which the cylindrical lens has been placed in the lens holder, and a plate spring is attached thereon in the light source unit in Embodiment 1 of the present invention;

FIG. 12 is a cross-sectional diagram showing the lens holder of the light source unit in Embodiment 1 of the present invention;

FIG. 13 is a cross-sectional diagram illustrating a state in which the cylindrical lens is placed in the lens holder of the light source unit in Embodiment 1 of the present invention;

FIG. 14 is a cross-sectional diagram illustrating a state in which the cylindrical lens has been placed in the lens holder, and the plate spring is attached thereon in the light source unit in Embodiment 1 of the present invention;

FIG. 15 is a perspective view showing a first lens barrel of the light source unit in Embodiment 1 of the present invention;

FIG. 16 is a perspective view showing a state in which the sub-assembly unit is inserted in the first lens barrel of the light source unit in Embodiment 1 of the present invention;

FIG. 17 is a perspective view showing a state in which the sub-assembly unit and cylindrical lenses are inserted in the first lens barrel of the light source unit in Embodiment 1 of the present invention;

FIG. 18 is a cross-sectional diagram showing a state in which the cylindrical lenses are inserted in the sub-assembly unit of the light source unit in Embodiment 1 of the present invention; and

FIG. 19 is a diagram illustrating a configuration of a projection displaying apparatus 600 using light source units according to Embodiment 1 of the present invention.

### DETAILED DESCRIPTION OF THE PREFERRED EMBODIMENTS

### Embodiment 1

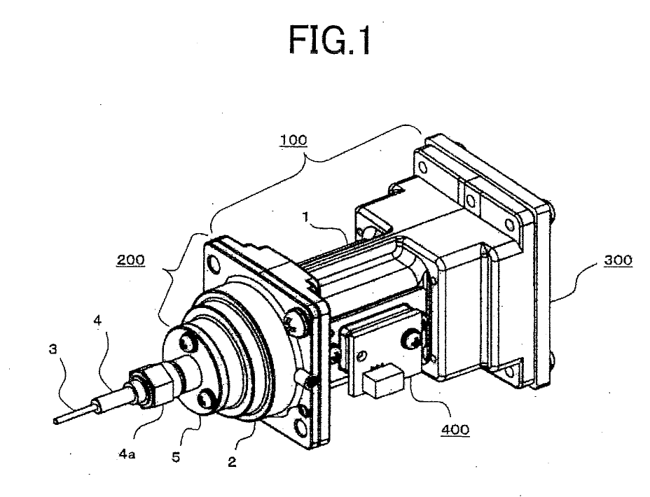

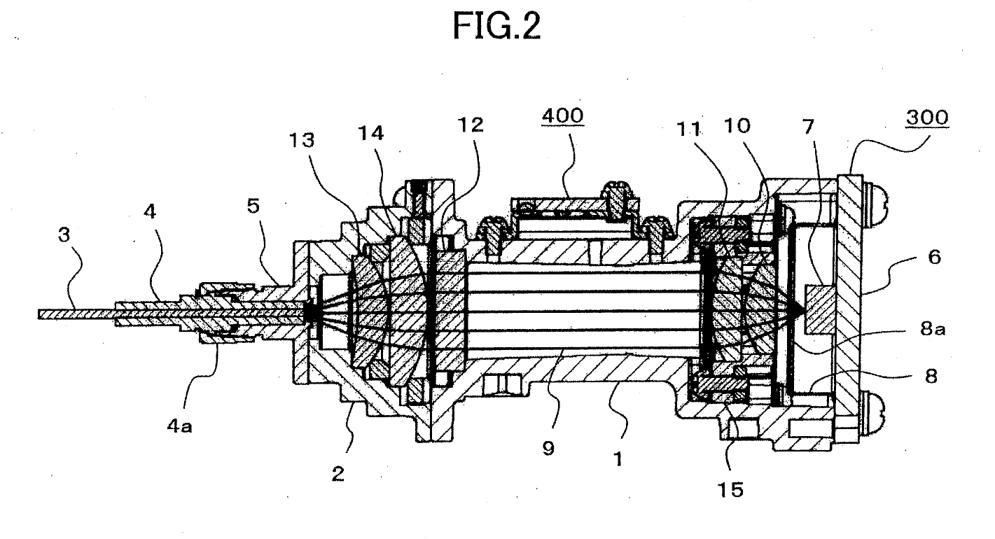

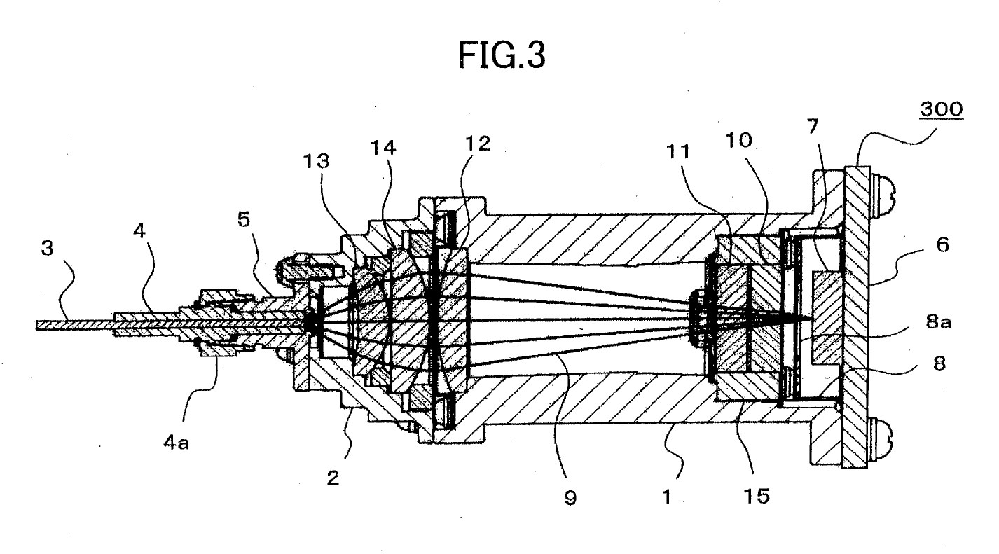

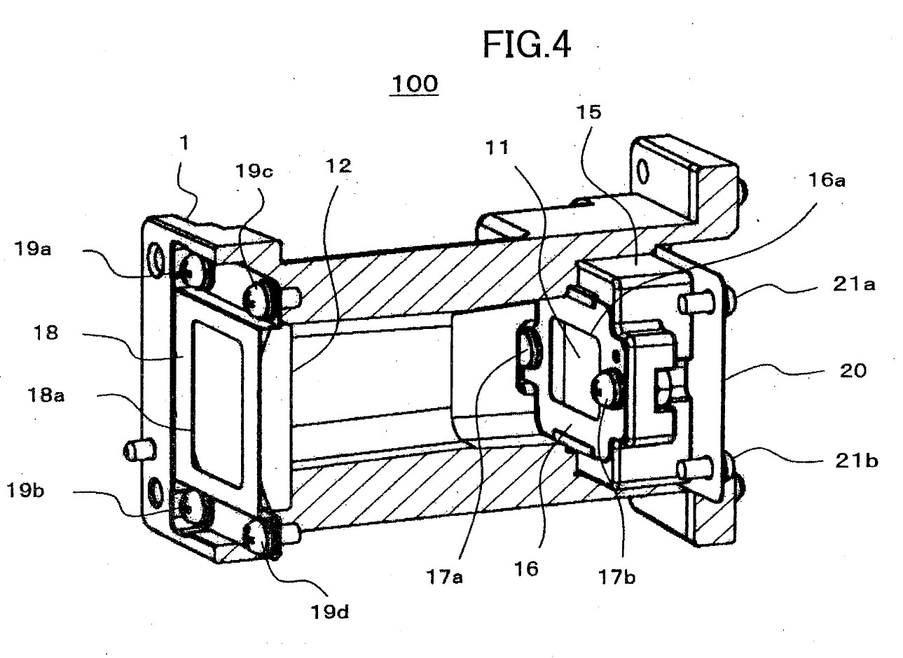

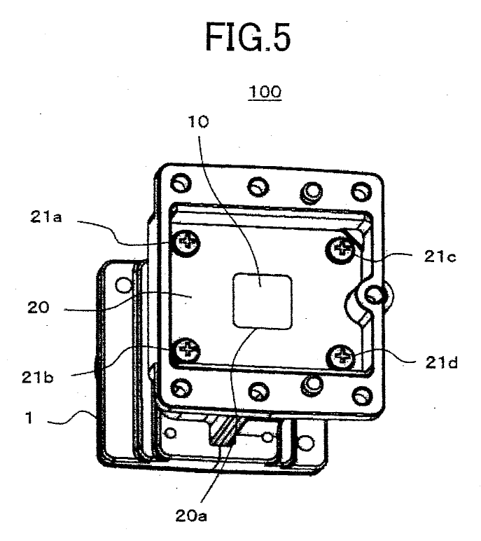

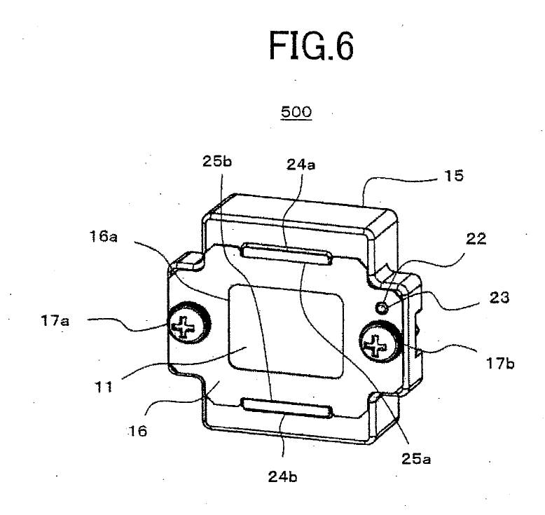

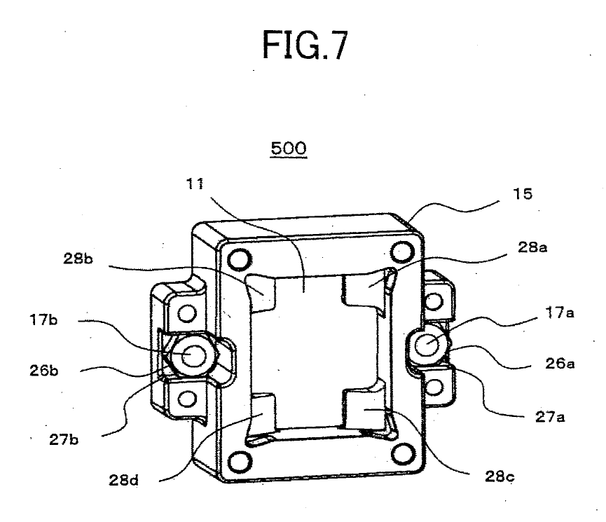

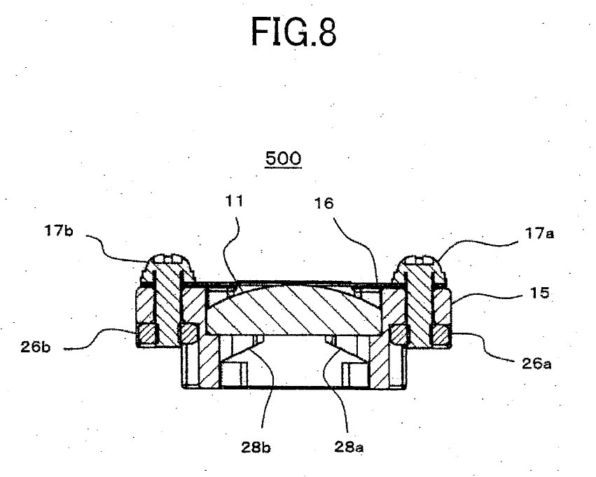

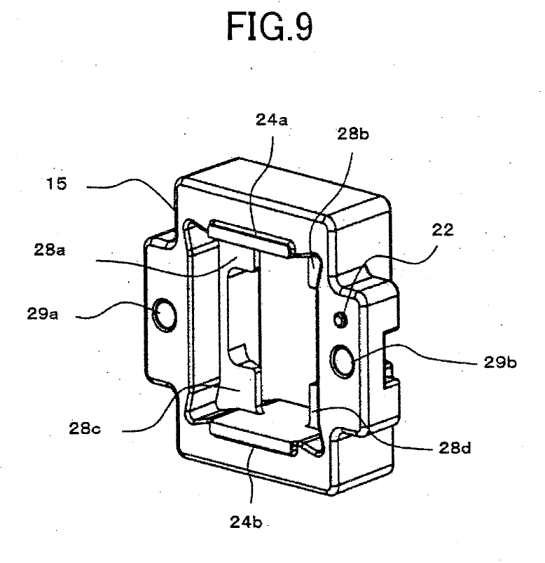

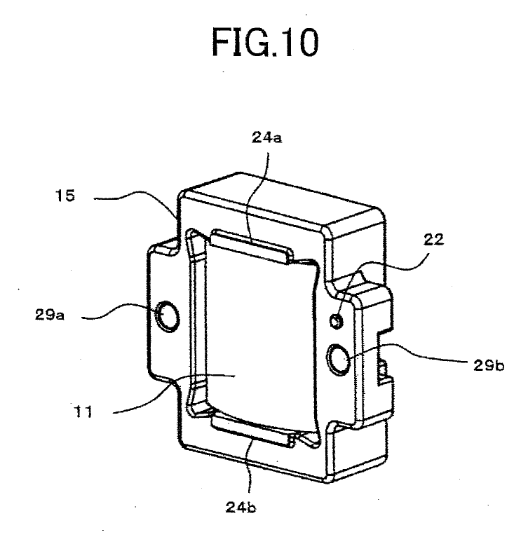

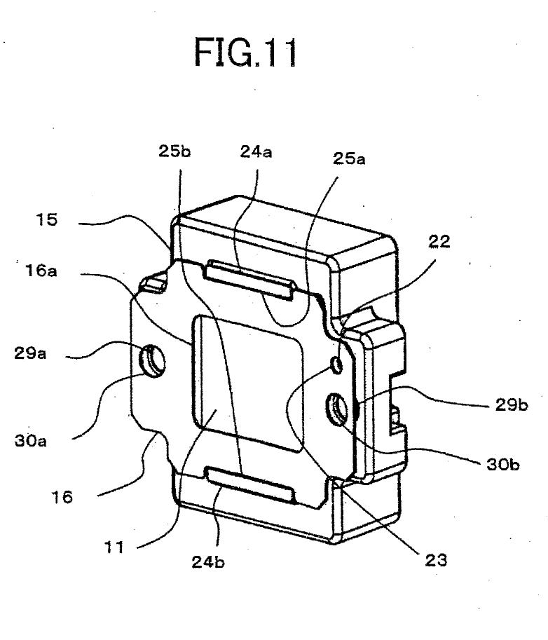

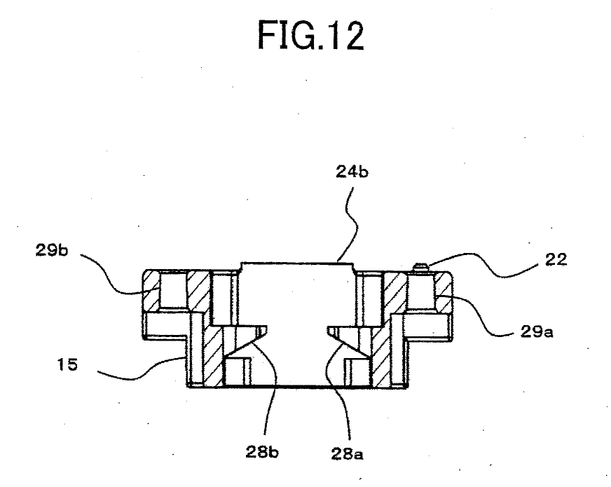

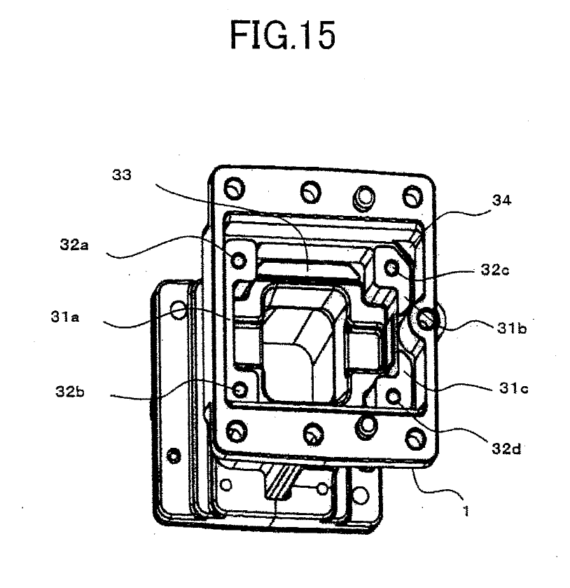

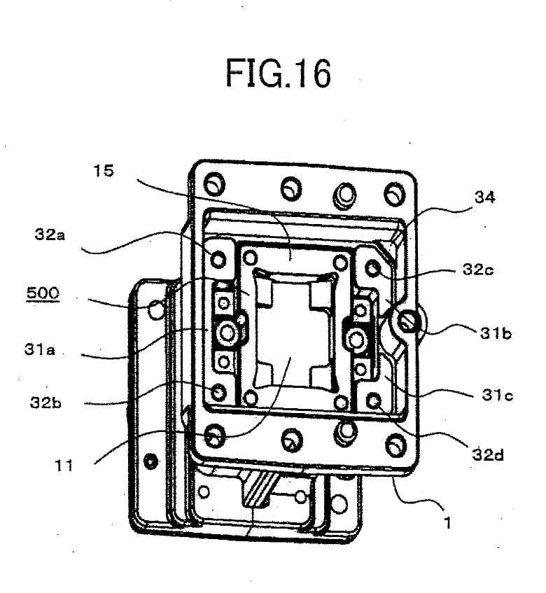

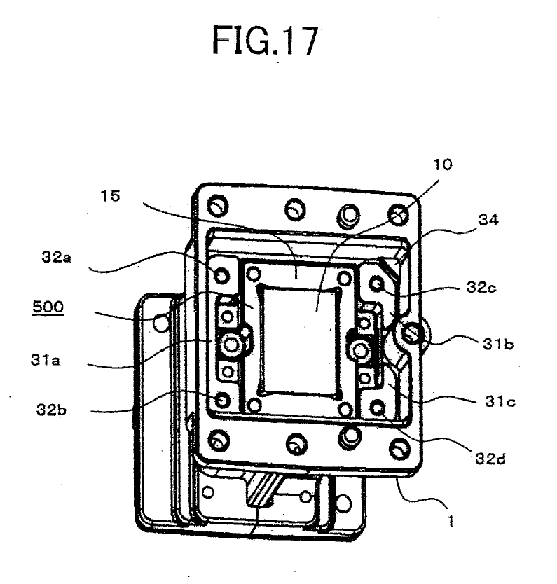

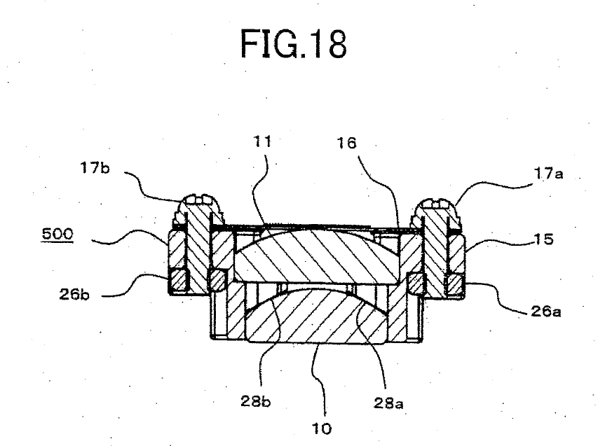

Hereunder, a light source unit according to Embodiment 1 of the present invention will be described in detail with reference to the accompanying drawings. FIG. 1 is a perspective diagram of the light source unit according to the embodiment. FIG. 2 is a lateral section diagram of the unit. FIG. 3 is a longitudinal section diagram of the unit. FIG. 4 is a perspective diagram of a lens unit 100 holding cylindrical lenses of the light source unit in which a longitudinal section is taken for a first lens barrel 1. FIG. 5 is a perspective view showing the lens unit 100 viewed from behind it, which holds the cylindrical lenses. FIG. 6 and FIG. 7 are perspective views each showing a sub-assembly unit 500 that holds a cylindrical lens. FIG. 8 is a cross-sectional diagram of the sub-assembly unit 500. FIG. 9 is a perspective view of a lens holder 15. FIG. 10 is a perspective diagram illustrating a state in which the cylindrical lens 11 is placed in the lens holder 15. FIG. 11 is a perspective diagram illustrating a state in which the cylindrical lens 11 has been placed in the lens holder 15, and a plate spring 16 is attached for covering. FIG. 12 through FIG. 14 are cross-sectional diagrams of FIG. 9 through FIG. 11, respectively. FIG. 15 is a perspective view of the first lens barrel 1 viewed from its entrance side. FIG. 16 is a perspective view showing a state in which the sub-assembly unit 500 is inserted in the first lens barrel 1. FIG. 17 is a perspective view showing a state in which the cylindrical lens 10 is placed in addition to the state in FIG. 16. FIG. 18 is a cross-sectional diagram of the sub-assembly unit 500 when the cylindrical lens 10 is placed therein.

As shown in FIG. 1, the light source unit in Embodiment 1 is constituted of the lens unit 100 having the first lens barrel 1 that holds the cylindrical lenses, a lens unit 200 having a second lens barrel 2 that holds round or circular lenses, an optical fiber holder 5 for fixing by a cap nut 4a a connector 4 that holds an optical fiber 3, a laser module 300 mounted at the rear end of the first lens barrel 1 for emitting a laser beam, and a light sensor unit 400 mounted on a lateral side of the first lens barrel 1 for detecting the laser beam.

As shown in FIG. 2 and FIG. 3, the laser module 300 is constituted of a base plate 6, a laser element 7 mounted thereon and a cap 8 mounted on the base plate 6 to seal the laser element 7, and is mounted being regularly positioned at the rear end of the first lens barrel 1. In the first lens barrel 1, three pieces of the cylindrical lenses 10, 11 and 12 are held. The cylindrical lens 10 and the cylindrical lens 11 are set having their generating lines or generatrices common in the same orientation, and are held in the first lens barrel 1 by way of the lens holder 15. In addition, the cylindrical lens 12 is held to have its generatrix perpendicular to the generatrices of the cylindrical lenses 10 and 11.

In the second lens barrel 2, two pieces of round or circular lenses 13 and 14 are held. The second lens barrel 2 is regularly positioned and mounted with respect to the first lens barrel 1 so that optical axes of the circular lenses 13 and 14 coincide with those of the cylindrical lenses 10, 11 and 12. In addition, the cylindrical lenses 10 and 11 are placed in the lens holder 15, and further, the lens holder 15 is held by means of the first lens barrel 1. As described above, a holding structure of the cylindrical lenses 10 and 11 is the double structure. In Embodiment 1, an example is described in which two neighboring cylindrical lenses are held by the lens holder 15; however, when one cylindrical lens is used on a design basis, only the one may be held by a lens holder.

The optical fiber 3 is inserted into the connector 4 so that the front end of the fiber on the side of the second lens barrel 2 coincides with the front end of the connector 4, and is fixed to the connector 4 by adhesive or the like. In addition, on the front end, i.e., on the exit side of the second lens barrel 2, the optical fiber holder 5 is mounted. Into the optical fiber holder 5, the front end of the connector 4 is inserted, which is fixed by the cap nut 4a. At this time, the front end of the connector 4 is stopped by touching at the bottom in a hole of the optical fiber holder 5, so that positioning of the front end of the optical fiber 3 is achieved in the axial direction thereof (in depth) with respect to the optical fiber holder 5. Note that, the optical fiber 3 shown in FIG. 1 through FIG. 3 indicates a state being cut partway for simplifying the illustrative diagrams; however, it is a general practice that the optical fiber is actually long with desired length and is also coated with covering material.

Next, the operations of the light source unit will be explained. A laser beam 9 is emitted from the laser element 7. The laser element 7 emits the laser beam 9 whose light-rays spread in lateral directions to a large extent as shown in FIG. 2 that is a lateral section diagram, and also spread in longitudinal directions to a small extent as shown in FIG. 3 that is a longitudinal section diagram. Next, the laser beam 9 emitted from the laser element 7 passes through a glass window 8a provided in the cap 8, and is made incident to the cylindrical lens 10. As shown in FIG. 2, the laser beam 9 made incident to the cylindrical lens 10 is refracted by the cylindrical lenses 10 and 11, so that the spread in the lateral directions is compensated, resulting in a parallel-ray laser beam. On the other hand, the cylindrical lenses 10 and 11 each do not have the curvature in longitudinal directions, so that, as shown in FIG. 3, light-rays of the laser beam 9 in the longitudinal directions hardly change their angles, i.e., pass through the cylindrical lenses 10 and 11.

The laser beam 9 that propagates through a hollow within the first lens barrel 1 is made incident to the cylindrical lens 12. The cylindrical lens 12 is placed to have its generating line or generatrix perpendicular to the generatrices of the cylindrical lenses 10 and 11, so that light-rays of the laser beam 9 that spread in lateral directions do not turn as shown in FIG. 2, and light-rays of the laser beam 9 that spread in longitudinal directions are refracted as shown in FIG. 3 to form a parallel-ray laser beam. According to the operations described above, the laser beam 9 emitted from the exit side of the cylindrical lens 12 is formed into the longitudinally and laterally parallel-ray laser beam.

Subsequently, the laser beam 9 incident to the circular lens 14 is refracted in longitudinal direction and lateral direction by the circular lens 14 and the circular lens 13, and is focused onto an entrance of the optical fiber 3. The laser beam 9 being incident to the optical fiber 3 is propagated within the optical fiber 3 so as to be transferred. As described above, the laser beam 9 emitted from the laser element 7, having different divergence angles in longitudinal direction and lateral direction, is formed into a longitudinally and laterally parallel-ray beam by a plurality of such cylindrical lenses 10 and 11, and 12 that are placed to have their respective generatrices perpendicular to one another, so that the laser beam can be easily focused without deviating from the front end of the optical fiber 3 by subsequently using the circular lenses 13 and 14.

Next, a configuration of the lens unit 100 will be explained. In the lens unit 100 shown in FIG. 4, the cylindrical lens 10 and the cylindrical lens 11 are placed in the lens holder 15, and are held on the entrance side of the first lens barrel 1 to which the laser beam 9 is made incident. Note that, placed on the back-surface side of the cylindrical lens 11 is the cylindrical lens 10, which is thus not illustrated in FIG. 4. On the other hand, the cylindrical lens 12 is held on the exit side of the first lens barrel 1 from which the laser beam 9 is emitted. In addition, the cylindrical lens 11 is pressed by a plate spring 16 toward the lens holder 15, and is securely held without looseness and excess play. The plate spring 16 is fastened onto the lens holder 15 by screws 17a and 17b.

The cylindrical lens 12 is directly fitted in the first lens barrel 1, and is fixed being spring-biased toward the lens-barrel side by a plate spring 18. The plate spring 18 is fastened onto the first lens barrel 1 by four pieces of screws 19a through 19d. In addition, the cylindrical lens 12 is placed to have its generatrix perpendicular to the generatrices of the cylindrical lenses 10 and 11. This is because the spread of the laser beam 9 in lateral directions is collimated by the cylindrical lenses 10 and 11, and the spread of the laser beam 9 in longitudinal directions is collimated by the cylindrical lens 12.

The cylindrical lens 10 is held, as shown in FIG. 5, by fixing a plate spring 20 from the entrance side of the first lens barrel 1 using four pieces of screws 21a through 21d. The cylindrical lens 10 is positioned as its planar side face being positioned beyond to some extent from an end-face of the lens holder 15, and is thus securely held without looseness and excess play by spring-biasing by means of the plate spring 20. Moreover, in the plate springs 16, 18 and 20, windows 16a, 18a and 20a are provided so that the laser beam 9 passes therethrough, respectively.

As described above, the cylindrical lenses 10 and 11, and 12 are held in proximities to the respective entrance and exit sides of the first lens barrel 1, and an embedded or nested structure is applied to place the lens holder 15 inside the first lens barrel 1, so that the first lens barrel 1 can be made as a single component in a tubular shape, and it is not only possible to reduce the number of components, but also easy to secure positional accuracy among a plurality of lenses; therefore, the stiffness of the lens barrel can be further enhanced, enabling reducing the thickness of material and also lowering costs.

Next, a configuration of the sub-assembly unit 500 that holds a cylindrical lens will be explained using FIG. 6 through FIG. 8. The sub-assembly unit 500 includes the cylindrical lens 11, the lens holder 15, the plate spring 16 that presses down the cylindrical lens 11, and the screws 17a and 17b with nuts 26a and 26b that fix the plate spring 16. In FIG. 8, the cylindrical lens 11 is inserted with its planar side face heading downward in the lens holder 15. In FIG. 6, on the lens holder 15, a positioning boss 22 for the plate spring is provided so as to fit into a positioning hole 23 provided in the plate spring 16, so that the position of the plate spring 16 is determined. The positioning boss 22 is provided at a position apart from longitudinal and lateral midlines of the lens holder 15. According to this arrangement, the plate spring 16 is not only positioned, but also mounted without mistaking the front or back side thereof.

In addition, on the lens holder 15, ribs 24a and 24b are provided so as to act as guides when the plate spring 16 is mounted onto the lens holder, and on both sides of the plate spring 16, cutouts 25a and 25b are provided at the positions to meet the ribs 24a and 24b, respectively. According to this arrangement, setting at a predetermined position is easy to accomplish when the plate spring 16 is attached on the lens holder 15. In addition, when the screw 17a or the screw 17b is fastened, it is possible to prevent the plate spring 16 from rotationally moving, whereby assembling the plate spring is easy, and its positioning can be reliably achieved. Note that, the plate spring 16 is screwed so as to press down the cylindrical lens 11 perpendicular to its generatrix. In addition, the ribs 24a and 24b are provided avoiding the areas used to be fastened by screws with the plate spring 16, that is, at the positions to guide the sides of the plate spring that are not fastened by the screws.

Moreover, the screws 17a and 17b are not directly screwed to and fixed in the lens holder 15, but are passed through the lens holder 15 and fastened by the nuts 26a and 26b from the back side thereof, as shown in FIG. 7 and FIG. 8. In addition, at places on the back side of the lens holder 15 in which the nuts 26a and 26b are positioned, provided are recesses 27a and 27b into which the nuts 26a and 26b fit, so that the nuts 26a and 26b will not turn idle when the screws 17a and 17b are fastened. According to the configuration, it is not necessary to cut a female screw-thread in the lens holder 15, and additional machining is not required when produced by die casting, so that reduction of costs can be achieved. In addition, in a case of die casting, if directly screwed to the lens holder, its screw hole may be destroyed; however, when an iron nut is used, the screw bole can avoid from being destroyed.

In order to hold the cylindrical lens 11, protrusions 28a through 28d are provided inside the lens holder 15 so as to make contact plurally with four corners of the cylindrical lens 11. As shown in FIG. 2 and FIG. 3, when the positions of the cylindrical lens 10 and the cylindrical lens 11 are very close to each other, it may generally be difficult to fix in place on a one-by-one basis the cylindrical lenses each having approximately the same outer dimensions. In addition, even by fixing a thin plate between the two cylindrical lenses inside the lens holder so that a contact or touch face is to be provided for positioning, their positions cannot be accurately determined due to a shortage of strength. For dealing therewith, the structure is adopted in which the four corners of the cylindrical lens 11 through which the laser beam 9 does not pass are supported by the protrusions 28a through 28d.

In FIG. 7, if the upper and lower protrusions 28a and 28c, and/or those protrusions 28b and 28d are bridged together, a light path of the laser beam 9 will be interfered in the middle portion of the bridged structure. If the left and right protrusions 28a and 28b, and/or those protrusions 28c and 28d are bridged together, it is inevitable that the widths of their bridged middle portions will be greatly reduced, resulting in difficulties in bridging them. According to the holding method here, it is possible to accurately hold the two neighboring cylindrical lenses by utilizing a slight amount of interspace between two pieces of cylindrical lenses placed in the same orientations adjacent to each other, and by holding them at positions avoiding the light path of the laser beam 9.

In addition, as shown in FIG. 18, the protrusions 28a through 28d are tapered so as to tangentially make contact with the cylindrical lens 10 along a curved face thereof at places where the protrusions 28a and 28b (28c and 28d are not shown in the figure) make contact with the curved face of the cylindrical lens 10. According to this arrangement, positioning of not only the cylindrical lens 11, but also the cylindrical lens 10 can be accurately performed, so that the basal area of the protrusions 28a through 28d each is made widen, and thus, strength thereof can be enhanced, resulting in achieving a strong holding against vibrations and impacts.

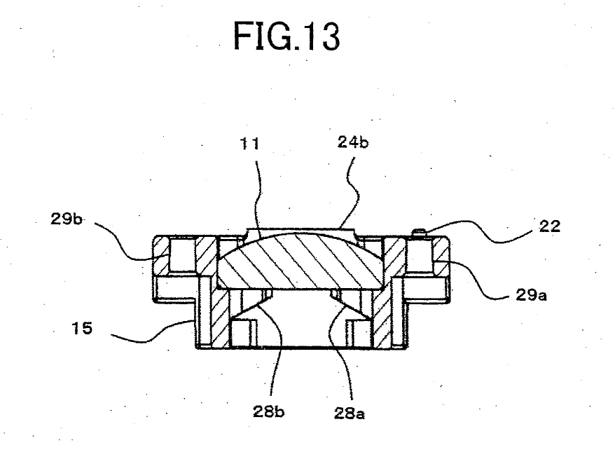

Next, the assembling procedures of the sub-assembly unit 500 will be explained by referring to FIG. 9 through FIG. 11, and to FIG. 12 through FIG. 14 that are respective cross-sectional diagrams. FIG. 9 and FIG. 12 each illustrate a state of the lens holder 15 alone. Holes 29a and 29b are through holes through which the screws 17a and 17b pass. As for the protrusions 28a through 28d, those faces that can be seen in FIG. 9 are arranged in the same planar surface to hold the bottom face of the cylindrical lens 11, so that their flatness is secured. FIG. 10 and FIG. 13 each illustrate a state in which the cylindrical lens 11 is inserted, and the bottom face (planar side face) of the cylindrical lens 11 is held by the protrusions 28a through 28d. Under the state, the front end of a curved face of the cylindrical lens 11 is designed being positioned beyond to some extent from the top face of the lens holder 15.

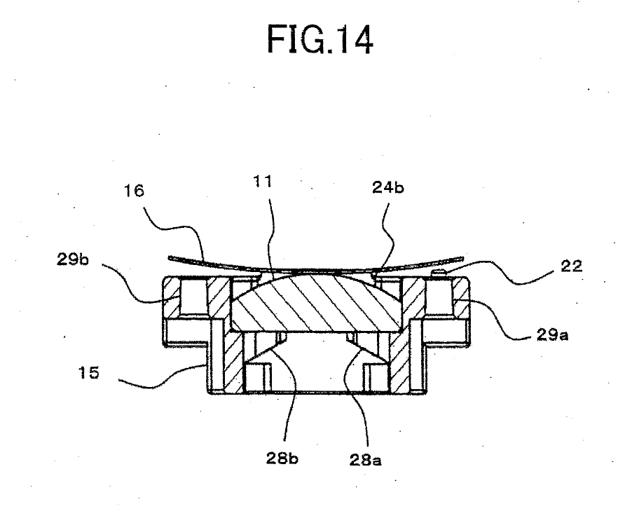

FIGS. 11 and 14 each illustrate a state in which the plate spring 16 is attached on the lens holder 15, and in the plate spring 16, provided other than the positioning hole 23 are holes 30a and 30b through which the screws 17a and 17b pass. In addition, to the plate spring 16, warpage is given in advance so that its face that makes contact with the cylindrical lens 11 is convex theretoward. Because the amount of extension of the cylindrical lens 11 beyond the lens holder 15 is very small, it is not possible to press down the cylindrical lens 11 toward the side of the lens holder 15, if the plate spring 16 is warped in the opposite direction. In that case, there is a possibility that the optical axis position of the cylindrical lens 11 may deviate from its intended position, so that the light source unit may have a negative effect on its performance.

In addition, when the amount of extension of the cylindrical lens 11 is increased, holding may be achieved even when the plate spring is warped in the opposite direction. However, in this instance, when the plate spring is warped in the normal direction, the pressure to press down the cylindrical lens 11 becomes higher, so that there are possibilities that the cylindrical lens 11 may become split or cracked. Accordingly, the amount of extension of the cylindrical lens 11 is minimized, and the warpage is given to the plate spring 16 in the specific direction, so that holding can be achieved reliably with the pressure that is uniform at all times. As described above, because the direction of the warpage of the plate spring 16 is specified, the positioning boss 22 and the positioning hole 23 that fits thereinto are provided in order not to mistake the front or back side of the plate spring 16 at the time of assembling.

As described above, the cylindrical lens 11, the lens holder 15 and other fastening components are brought to a sub-assembly to provide the sub-assembly unit 500, so that the cylindrical lens 11 can be easily and accurately assembled. In addition, because of using sub-assembly, the cylindrical lenses 10 and 11 can be inserted from the respective front and back sides of the lens holder 15, and thus, holding of the two neighboring pieces of the cylindrical lenses is made possible. Moreover, because mutual positioning of the cylindrical lenses is made together with the lens holder 15 and the number of the components is reduced, reduction of costs can be achieved.

Next, the assembling procedures of the first lens barrel 1 and the sub-assembly unit 500 will be explained referring to FIG. 15 through FIG. 17. In FIG. 15, the first lens barrel 1 is in a stand-alone state in which provided thereinside are touch faces 31a through 31c for the plate spring 20 shown in FIG. 5, and further formed therein are screw holes 32a through 32d for fastening the plate spring 20. In addition, at recessed positions in the lens barrel, touch faces 33 for the sub-assembly unit 500 are formed. Although FIG. 15 cannot show because of a perspective view, there also exists a similar touch face below. The numeral “34” shows a positioning protrusion for the plate spring 20 shown in FIG. 5, and acts to prevent from mistaking the front or back side of the plate spring 20.

FIG. 16 shows a state in which the sub-assembly unit 500 is inserted in the first lens barrel 1, and the front surface of the lens holder 15 is made contact with the touch faces 33 in FIG. 15, whereby positioning in the optical axis direction is thus achieved. Because the cylindrical lens 11 is held by the lens holder 15, and is placed at a predetermined position by solely inserting the sub-assembly unit 500 into the first lens barrel 1, its positioning is made without such a difficulty which is associated with positioning being proceeded by setting far back in the first lens barrel 1 to hold in place, and thus, assembling is very easy to process.

FIG. 17 shows a state in which the cylindrical lens 10 is further inserted, i.e., the curved face thereof heads downward as inserted in the lens holder 15. Under the state, the cylindrical lens 10 is positioned as its face on the entrance side (planar side face) thereof being positioned beyond by only some extent from the touch faces 31a through 31c. Next, the state in FIG. 5 is obtained by placing the plate spring 20 having its cut out on the right upper side so as to meet the positioning protrusion 34, and by fastening the plate spring by the screws 21a through 21d. Note that, FIG. 18 is a cross-sectional diagram of the sub-assembly unit 500 showing a state in which the cylindrical lens 10 is inserted therein as in FIG. 17.

Since such a configuration has been utilized as described above, by pressing down the cylindrical lens 10 by the plate spring 20, it is possible to fix not only the cylindrical lens 10, but also the sub-assembly unit 500 at the same time; therefore, two neighboring pieces of the cylindrical lenses 10 and 11 can be held at the same time.

Note that, the plate spring 20 that presses down the cylindrical lens 10 may be formed warping toward the cylindrical lens 10 so as to make contact therewith. In this case, it is possible to press down the cylindrical lens 10 with a constant pressure by the plate spring 20, so that it becomes possible to reliably hold the cylindrical lens 10.

### Embodiment 2

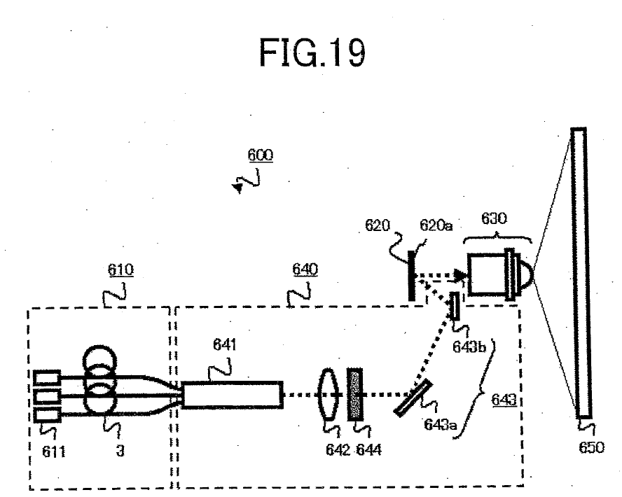

FIG. 19 is a diagram illustrating a configuration of a projection displaying apparatus 600 as an image displaying apparatus using light source units according to Embodiment 1 of the present invention. The projection displaying apparatus 600 is a rear projection television that projects images onto a screen using a light valve.

As shown in FIG. 19, the projection displaying apparatus 600 according to Embodiment 2 includes a condensing optical system 610, an illumination optical system 640, a reflection-type light modulation device (reflection-type light valve) 620 as an image displaying device, and a projection optical system 630 that enlarges and projects onto the transmission-type screen 650 images on an illumination surface (image producing area) 620a of the reflection-type light modulation device 620 which is illuminated by the illumination optical system 640.

The condensing optical system 610 is constituted of light source units 611 having a plurality of colors (three colors in FIG. 19) and a plurality of pieces (three pieces in FIG. 19) of such optical fibers 3 that guide light beams emitted from the light source units 611 into the illumination optical system 640. Among the light source units 611 having the plurality of colors, at least one is the light source unit according to Embodiment 1.

In the condensing optical system 610, laser beams emitted from the light source units 611 are guided into the illumination optical system 640 by way of the optical fibers 3 corresponding to the light source units 611.

The illumination optical system 640 includes a light intensity uniformizing device 641 that uniformly distributes the intensity of laser beams emitted from the condensing optical system 610 (optical fibers 3), a relay-lens group 642, a diffusion device 644, and a mirror group 643 constituted of a first mirror 643a and a second mirror 643b. The illumination optical system 640 thus guides by means of the relay-lens group 642 and the mirror group 643 a light beam emitted from the light intensity uniformizing device 641 onto the reflection-type light modulation device 620.

The light intensity uniformizing device 641 has a function to uniformize the light intensity of the laser beams (for example, a function to reduce inconsistencies of illuminance) emitted from the condensing optical system 610. The light intensity uniformizing device 641 is disposed in the illumination optical system 640 so that an incident face (incident end-face) that is an entrance of incident light is set facing toward the optical fibers 3, and an emission face (emission end-face) that is a light emission exit is set facing toward the relay-lens group 642.

The light intensity uniformizing device 641 is made of a transparent material, for example, glass, resin or the like. The light intensity uniformizing device 641 includes a polygonally columned rod (columned member having its cross-sectional shape polygonal) whose sidewall has an internal surface of total reflection, or a polygonal pipe (tubular member) having inwardly arranged light reflection surfaces tubularly combined with its cross-sectional shape polygonal.

When the light intensity uniformizing device 641 is a polygonally columned rod, light is emitted from an emission end (emission exit) after having light reflected a number of times by utilizing a total reflection action on an interface between a transparent material and air.

When the light intensity uniformizing device 641 is a polygonal pipe, light is emitted from the emission exit after having light reflected a number of times by utilizing a reflection action by the surface mirror inwardly facing.

When an appropriate length is secured for the light intensity uniformizing device 641 in the traveling direction of the light beam, the light internally reflected a number of times is superimposed and emitted in proximity to the emission face of the light intensity uniformizing device 641; therefore, a substantially uniform intensity distribution can be obtained in the proximity to the emission face of the light intensity uniformizing device 641. Light emitted from the emission face having the substantially uniform intensity distribution is guided by the relay-lens group 642 and the mirror group 643 onto the reflection-type light modulation device 620, so that the illumination surface 620a of the reflection-type light modulation device 620 is illuminated.

In addition, in the illumination optical system 640, the diffusion device (diffusing portion) 644 is provided downstream of the relay-lens group 642. The diffusion device 644 is a device that reduces speckle by diffusing the light propagated by way of the relay-lens group 642 and then by sending it to the mirror group 643. The diffusion device 644 is a holographic diffusion device or the like that can specify light diffusion angles using a hologram pattern provided on the substrate, and that mitigates coherency attributed to the light source units 611.

In addition, by rotating, moving or vibrating the diffusion device 644, or doing the like, the coherency attributed to the light source units 611 can be effectively mitigated.

The reflection-type light modulation device 620 is, for example, a light modulation device of a reflection-type such as a digital micromirror device (DMD). The reflection-type light modulation device 620 is configured in such a manner that a large number of movable micromirrors corresponding to pixels each (for example, hundreds of thousands of pieces) are arranged in a planar surface, and a slope angle (tilt) of each of the micromirrors is changed depending on pixel information.

The projection optical system 630 enlarges and projects onto a transmission-type screen 650 images on the illumination surface (image producing area) 620a of the reflection-type light modulation device 620. According to this arrangement, the images are displayed on the transmission-type screen 650.

Note that, shown in FIG. 19 is a case in which the relay-lens group 642 is configured by one lens; however, the lens number is not limited to one, and a plurality of lenses may be used. Likewise, as for the mirror group 643, the mirrors are not limited to two, and the mirror group 643 may be configured by one, or by three or more mirrors.

Note that in FIG. 19, laser beams emitted from the light source units 611 having a plurality of colors are guided into the illumination optical system 640 by way of the optical fibers 3 corresponding to the respective light source units 611; however, laser beams emitted from the light source units 611 may be combined using a dichroic mirror or the like, and then be incident to the illumination optical system 640.

While the present invention has been shown and described in detail, the foregoing description is in all aspects illustrative and not restrictive. It is therefore understood that numerous modifications and variations can be realized without departing from the scope of the invention.

### EXPLANATION OF NUMERALS AND SYMBOLS

“1” designates a first lens barrel; “2,” second lens barrel; “3,” optical fiber; “7,” laser element; “9,” laser beam; “10,” “11,” “12,” cylindrical lens; “13,” “14,” circular lens; “15,” lens holder; “16,” plate spring; “17a,” “17b,” screw; “20,” plate spring; “22,” positioning boss; “23,” positioning hole; “24a,” “24b,” rib; “26a,” “26b,” nut; “27a,” “27b,” hollow; “28a,” through “28d,” protrusion; “100,” “200,” lens unit; “300,” laser module; “400,” light sensor unit; “500,” sub-assembly unit; and “600,” projection displaying apparatus.

1. A light source unit, comprising:
at least one cylindrical lens placed with its generatrix perpendicular to an optical axis of laser beam for forming a parallel-ray laser beam by refracting the laser beam having different divergence angles in longitudinal direction and lateral direction emitted from a laser element;
a condenser lens placed downstream of the at least one cylindrical lens for focusing the parallel-ray laser beam;
a lens holder for holding the at least one cylindrical lens;
a first lens barrel into which the lens holder is inserted; and
a second lens barrel mounted on the first lens barrel for holding the condenser lens so that an optical axis thereof coincides with an optical axis of the at least one cylindrical lens.

2. The light source unit as set forth in claim 1, wherein the lens holder has a protrusion that is made contact with the at least one cylindrical lens so as to position the at least one cylindrical lens along the optical axis thereof.

3. The light source unit as set forth in claim 1, wherein the condenser lens focuses the parallel-ray laser beam onto an entrance of an optical fiber placed downstream of the condenser lens.

4. The light source unit as set forth in claim 1, wherein the condenser lens focuses the parallel-ray laser beam onto an entrance of a light intensity uniformizing device placed downstream of the condenser lens.

5. The light source unit as set forth in claim 2, wherein
the at least one cylindrical lens includes a first cylindrical lens placed on a side of the second lens barrel, and a second cylindrical lens placed on a side of the laser element; and
the protrusion is placed between the first cylindrical lens and the second cylindrical lens, and has a first contact face that is made contact with the first cylindrical lens, and a second contact face that is made contact with the second cylindrical lens.

6. The light source unit as set forth in claim 5, wherein the protrusion is made contact with the first cylindrical lens at four corners thereof.

7. The light source unit as set forth in claim 5, wherein the second contact face is tapered so as to tangentially make contact with the second cylindrical lens along a curved face thereof.

8. The light source unit as set forth in claim 1 wherein
the at least one cylindrical lens includes a first cylindrical lens placed on a side of the second lens barrel, and a second cylindrical lens placed on a side of the laser element; and
the first cylindrical lens is inserted in the lens holder, and is held in the lens holder by a plate spring that presses the first cylindrical lens, a screw that passes through the plate spring and the lens holder, and a nut that engages with the screw.

9. The light source unit as set forth in claim 1, wherein
the at least one cylindrical lens includes a first cylindrical lens placed on a side of the second lens barrel, and a second cylindrical lens placed on a side of the laser element;
the second cylindrical lens is inserted in the lens holder; and
the lens holder is pressed and held in the first lens barrel, together with the second cylindrical lens, by a plate spring that presses the second cylindrical lens.

10. The light source unit as set forth in claim 8, wherein
the lens holder has a positioning boss at a position apart from a midline of the lens holder; and
the plate spring has a positioning hole that engages with the positioning boss of the lens holder, and is warped convexly toward the first cylindrical lens with which the plate spring is made contact, in a plane perpendicular to a generatrix of the first cylindrical lens.

11. The light source unit as set forth in claim 10, wherein the lens holder has a rib on a face thereof on which the plate spring is mounted so as to engage with the plate spring.

12. The light source unit as set forth in claim 9, wherein the plate spring is warped convexly toward the second cylindrical lens with which the plate spring is made contact, in a plane perpendicular to a generatrix of the second cylindrical lens.

13. An image displaying apparatus including an image displaying device for producing, on its illumination area being illuminated, an image to be displayed on a screen, comprising:
a light source unit as set forth in claim 1;
an illumination optical system for illuminating the image displaying device by a laser beam emitted from the light source unit; and
a projection optical system for enlarging and projecting the image produced on the image displaying device onto the screen.
